(19) United States
(12) Patent Application Publication
(10) Pub. No.: US 2018/0257742 A1
(43) Pub. Date: Sep. 13, 2018

(54) SPROCKET ASSEMBLY OF BICYCLE

(71) Applicant: DRIVETRAIN TECH SOLUTION INC., Taichung (TW)

(72) Inventor: PO-CHENG CHEN, Taichung (TW)

(73) Assignee: Drivetrain Tech Solution Inc.

(21) Appl. No.: 15/456,826

(22) Filed: Mar. 13, 2017

(51) Int. Cl. B62M 9/10; F16H 55/30

(52) U.S. Cl. CPC B62M 9/10; F16H 55/30

(57) ABSTRACT

A sprocket assembly of a bicycle includes a plurality of sprockets with different sizes and a support device. Each of the sprockets has a rim portion and a plurality of teeth projected from the rim portion. The support device has a plurality of connecting members to be connected to the sprockets. Each of the connecting members has a plurality of stepped portions in a series connection, and each of the stepped portions has a first stepped face and a second stepped face. A distance between the first stepped face and a front face of the tooth is greater or equal to a thickness of the tooth, and a distance between the first stepped faces of the neighboring stepped portions is greater than the thickness of the tooth.

### BACKGROUND OF THE INVENTION

### 1. Technical Field

The present invention relates to a bicycle, and more particularly to a sprocket assembly of bicycle.

### 2. Description of Related Art

Typically, a conventional bicycle is equipped with a sprocket assembly on a rear wheel. The sprocket assembly includes a plurality of sprockets with different sizes. Each sprocket has teeth at an edge thereof to engage a chain. In the model design of bicycles, a weight of a bicycle is reduced, and therefore, the sprocket assembly is made of a light material. However, such light sprocket assembly usually has insufficient strength.

U.S. Pat. No. 4,642,075 disclosed a double sprockets made by pressing molding. The sprockets are connected together by a bridge member. This patent provides a cheap way to manufacture a sprocket assembly with multiple sprockets, and differences the numbers of teeth of the sprockets are large.

U.S. Pat. No. 7,118, 505 disclosed a conventional sprocket assembly with the sprockets initially molded together. There are connectors between the sprockets to connect them, but such sprocket assembly still has insufficient strength.

U.S. Pat. No. 8,342,994 disclosed another conventional sprocket assembly, in which the sprockets initially molded together, and each sprocket has teeth thicker than the rest part. This conventional sprocket assembly still has the problem of insufficient strength.

### BRIEF SUMMARY OF THE INVENTION

In view of the above, the primary objective of the present invention is to provide a sprocket assembly of a bicycle, which is light in weight.

The secondary objective of the present invention is to provide a sprocket assembly of a bicycle, which has a great strength to transmit large torque.

In order to achieve the objective of the present invention, a sprocket assembly of a bicycle includes a plurality of sprockets with different sizes and a support device. The sprockets are arranged side by side in an order from the biggest sprocket to the smallest sprocket. The neighboring sprockets are kept with an interval therebetwen. Each of the sprockets has a rim portion and a plurality of teeth projected from the rim portion. Each of the teeth has a front face, and the front face faces the neighboring sprocket with the small size. The support device has a plurality of connecting members, wherein the connecting members are separated from each other, and connected to the sprockets. Each of the connecting members has a plurality of stepped portions in a series connection, and each of the stepped portions has a first stepped face and a second stepped face. Ends of the first stepped face and the second stepped face are connected to opposite sides of the rim portion.

A distance between the first stepped face and the front face of the tooth is greater or equal to a thickness of the tooth, and a distance between the first stepped faces of the neighboring stepped portions is greater than the thickness of the tooth.

In an embodiment, the support further has a hub, a ring, and a plurality of connecting rods; ends of the connecting members are connected to the hub, and opposite ends of the connecting rods are connected to the connecting members and the ring respectively.

In an embodiment, the second stepped face of the stepped portion is connected to the rim portion of the sprocket and the first stepped portion of the next stepped portion to form the interval of the sprockets.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the bicycle of a preferred embodiment of the present invention;

FIG. 2 is a sectional view of the chain of the preferred embodiment of the present invention;

FIG. 3 is another sectional view of the preferred embodiment of the present invention; and

FIG. 4 is a sectional view of the link unit of the preferred embodiment of the present invention, showing the connecting member and the sprockets.

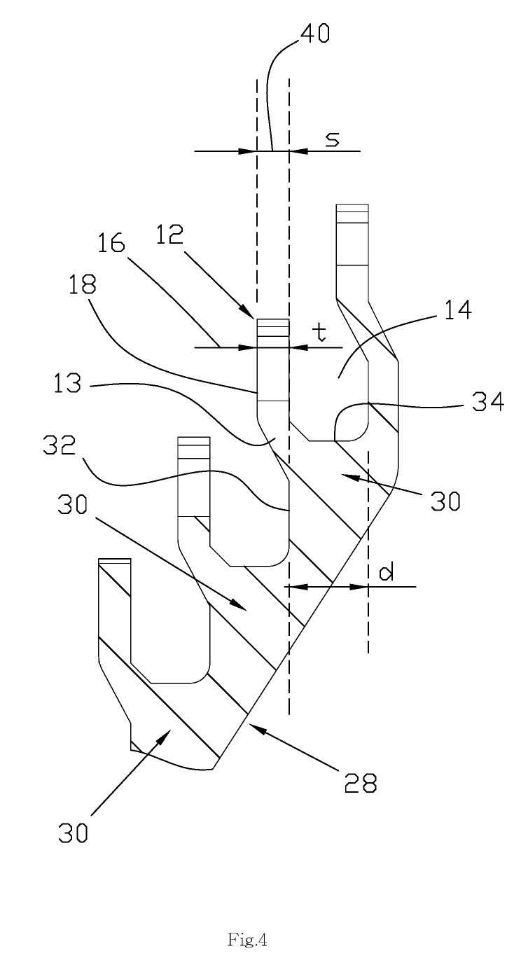

### DETAILED DESCRIPTION OF THE INVENTION

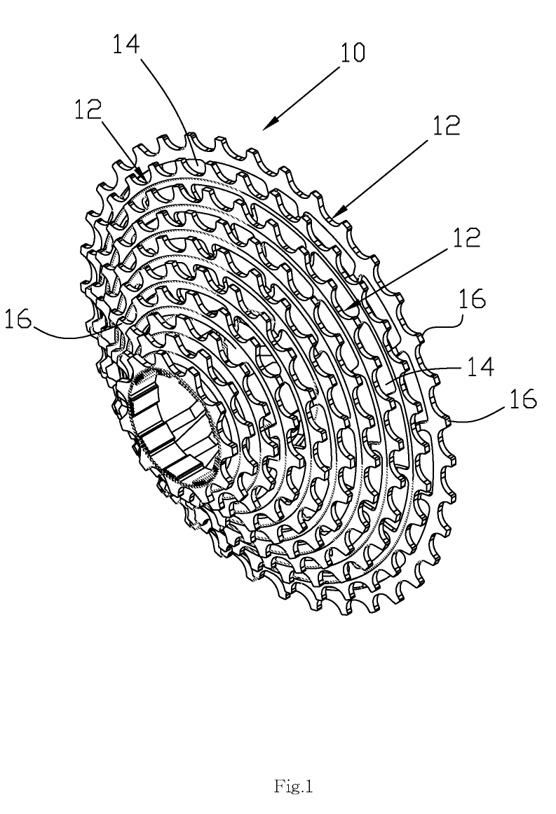

FIG. 1 shows a sprocket assembly 10 of the preferred embodiment of the present invention, which is mounted on a hub of a rear wheel of a bicycle (not shown). The sprocket assembly 10 engages a chain (not shown) to transmit torque.

The sprocket assembly 10 includes a plurality of sprockets 12 with different sizes. The sprockets 12 are arranged side by side in an order of the smallest sprocket 12 to the biggest sprocket 12. The neighboring sprockets 12 are kept a predetermined distance therebetween. Each sprocket 12 has a plurality of teeth 16 on an edge thereof.

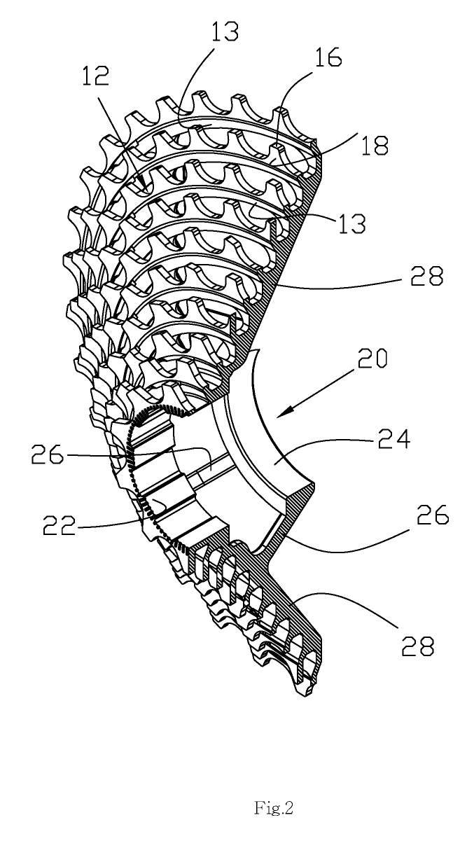

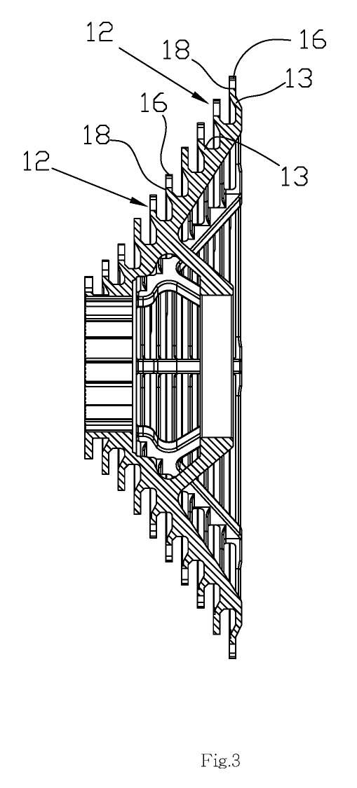

As shown in FIGS. 2 and 3, each sprocket 12 has a rim portion 13, and both sides of the rim portion 13 are inclined. The teeth 16 are connected to an outer edge of the rim portion 13. Each tooth 16 has a front face 18 facing the smaller sprocket 12.

The sprocket assembly 10 includes a support device 20, including a hub 22, a ring 24, a plurality of connecting rods 26, and a plurality of connecting members 28. The connecting members 28 are kept a predetermined distance from each other, and arranged in a beveled pattern. The connecting members 28 are connected to the rim portions 13 of the sprockets 12. The hub 22 and the ring 24 are provided at a center of the sprocket assembly 10. Proximal ends of the connecting members 28 are connected to the hub 22. The connecting rods 26 have opposite ends connected to the connecting members 28 and the ring 24 respectively.

With the above structure, the sprocket assembly 10 is formed as a single element with the support device 20 connecting the sprockets 12.

Each connecting member 28 has a plurality of stepped portions 30 in a series connection to connect the rim portions 13 of the sprockets 13. Each stepped portion 30 has a first stepped face 32 and a second stepped face 34. The first stepped faces 32 are connected to the second stepped faces 34 of the neighboring stepped portion 30 respectively. Ends of the first and the second stepped faces 32, 34 of the connecting members 28 are connected to opposite sides of the corresponding rim portion 13 of the sprockets 12 respectively. The first stepped faces 32 are parallel to the front faces 18 of the teeth 16, and there is a distance 40 between the first stepped face 32 and the corresponding front face 18. The second stepped face 34 of the stepped portion 30 has opposite ends connected to the rim portion 13 of the sprocket 12 and the first stepped portion 32 of the next stepped portion 30 to form the interval 14 of the sprockets 12.

Suppose that the distance 40 is s, and a thickness of the tooth 16 is t. The preferred embodiment of the present invention provides that the distance 40 between the first stepped face 32 and the corresponding front face 18 is greater than or equal to the thickness of the tooth 16 (s≥t).

Suppose that a thickness of the stepped portion 30 is d, which is a distance between the neighboring first stepped faces 32. The preferred embodiment of the present invention provides that the thickness of the stepped portion 30 is greater than the thickness of the tooth 16 (d>t).

The sprocket assembly 10 of the preferred embodiment of the present invention has the following advantages:

(1). The sprocket assembly 10 is made into a single element with a great strength.

(2). The connecting members 28 are separated from each other that makes the sprocket assembly 10 have several hollow portions at the interval 14 between the sprockets 12. It reduces a weight of the sprocket assembly 10, and keeps a sufficient strength.

(3). The sprocket assembly 10 is provided with the inclined rim portions 13, the distance 40 between the first stepped face 32 and the corresponding front face 18 greater than or equal to the thickness of the tooth 16, and the thickness of the stepped portion 30 greater than the thickness of the tooth 16 that makes the sprocket assembly 10 able to transmit large torque.

It must be pointed out that the embodiments described above are only some preferred embodiments of the present invention. All equivalent structures which employ the concepts disclosed in this specification and the appended claims should fall within the scope of the present invention.

What is claimed is:

1. A sprocket assembly of a bicycle, comprising:
a plurality of sprockets with different sizes, wherein the sprockets are arranged side by side in an order from the biggest sprocket to the smallest sprocket; the neighboring sprockets are kept with an interval therebetwen; each of the sprockets has a rim portion and a plurality of teeth projected from the rim portion; each of the teeth has a front face, and the front face faces the neighboring sprocket of the small size;
a support device having a plurality of connecting members, wherein the connecting members are separated from each other and connected to the sprockets;
wherein each of the connecting members has a plurality of stepped portions in a series connection, and each of the stepped portions has a first stepped face and a second stepped face; ends of the first stepped face and the second stepped face are connected to opposite sides of the rim portion;
wherein a distance between the first stepped face and the front face of the tooth is greater or equal to a thickness of the tooth, and a distance between the first stepped faces of the neighboring stepped portions is greater than the thickness of the tooth.

2. The sprocket assembly of claim 1, wherein the support further has a hub, a ring, and a plurality of connecting rods; ends of the connecting members are connected to the hub, and opposite ends of the connecting rods are connected to the connecting members and the ring respectively.

3. The sprocket assembly of claim 1, wherein the second stepped face of the stepped portion is connected to the rim portion of the sprocket and the first stepped portion of the next stepped portion to form the interval between the neighboring sprockets.
